(19) United States
(12) Patent Application Publication
(10) Pub. No.: US 2026/0087241 A1
(43) Pub. Date: Mar. 26, 2026

(54) GENERATING LAYER-AWARE AND OBJECT-AWARE ANNOTATIONS

(71) Applicant: Adobe Inc., San Jose, CA (US)

(72) Inventors: Ansh Gupta, New Delhi (IN); Praveen Gelra, Noida (IN); Ajay Bedi, Hamirpur (IN)

(21) Appl. No.: 18/895,077

(22) Filed: Sep. 24, 2024

(51) Int. Cl. G06F 40/169; G06F 40/205; G06F 40/279

(52) U.S. Cl. CPC G06F 40/169; G06F 40/205; G06F 40/279

(57) ABSTRACT

The present disclosure relates to systems, methods, and non-transitory computer-readable media that performs layer-aware and object-aware comments in a digital design document. For example, the disclosed systems receive a comment (that mentions an object) for a digital design document that includes one or more layers and one or more objects. Moreover, the disclosed systems generate an association between the comment, a layer of the one or more layers, and the object of the one or more objects. Further, the disclosed systems provide for display in the digital design document, an annotation on the object in the layer of the digital design document.

### BACKGROUND

Recent years have seen significant advancements in hardware and software platforms for creating and modifying digital design documents. For example, many platforms offer software applications that provide tools to modify objects within digital design documents and to further collaborate with other client devices. For instance, many platforms provide comments as part of a digital editing workflow. Despite advancements in creating and modifying digital illustration documents in a collaborative pipeline, conventional platforms suffer from a variety of issues in relation to accuracy, efficiency, and operational flexibility.

### SUMMARY

One or more embodiments described herein provide benefits and/or solve one or more of problems in the art with systems, methods, and non-transitory computer-readable media for generating a mapping between a comment, a relevant object, and a relevant layer of a digital design document. For example, in one or more embodiments, the disclosed systems receive a comment for a digital design document, where the digital design document includes one or more layers and one or more objects. Further, in one or more embodiments the disclosed systems generate an association (e.g., a mapping) between the comment, a layer, and an object. Accordingly, in response to a selection of the comment via a client device, the disclosed systems provide for display an annotation on the object in the layer of the digital design document. Specifically, the annotation indicates the association between the comment, the layer, and the object.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a comment aware system operates in accordance with one or more implementations;

FIG. 2 illustrates an overview diagram of the comment aware system providing for display an annotation on the object in the layer of the digital design document in accordance with one or more implementations;

FIG. 3 illustrates a diagram of the utilizing a text and image transformer model to generate an output segmentation mask in accordance with one or more implementations;

FIG. 4 illustrates a diagram of the comment aware system using an object detection model to generate an association between the comment, the layer, and the object in accordance with one or more implementations;

FIGS. 5A-5C illustrates example graphical user interfaces of the comment aware system providing for display a mask as the annotation on the object to indicate the association between the comment, the object, and the layer in accordance with one or more implementations;

FIGS. 6A-6C illustrates example graphical user interfaces of the comment aware generating an updated association between the comment, the object, and the layer in accordance with one or more implementations;

FIGS. 7A-7E illustrates example graphical user interfaces of the comment aware system generating associations for multiple comments and providing for display the relevant annotations in accordance with one or more implementations;

FIG. 8 illustrates a schematic diagram of the comment aware system in accordance with one or more implementations;

FIG. 9 illustrates a flowchart of a series of acts for providing a annotation on an object in accordance with one or more implementations;

FIG. 10 illustrates a block diagram of an exemplary computing device in accordance with one or more implementations.

### DETAILED DESCRIPTION

One or more embodiments described herein include a comment aware system that improves a digital design document editing pipeline by mapping an comment (e.g., a comment) to a relevant object and a relevant layer in a digital design document. For example, in one or more embodiments, the comment aware system automatically associates a comment (e.g., from a reviewing client device) in a digital design document to the correct region and object (e.g., without manual intervention) in response to a client device accessing the digital design document (e.g., a designer client device opening the digital design document). Specifically, the comment aware system leverages a text and image transformer model and an object detection model to generate the association between the comment, the layer, and the object. Moreover, the comment aware system automatically provides an annotation (e.g., a pin or a mask) in the graphical user interface on the object in the layer of the digital design document in response to generating the association. Moreover, in response to a selection of the annotation, the comment aware system causes the graphical user interface to display an indication of the association (e.g., the comment is associated with a specific layer, such as a beach layer).

As just mentioned, the comment aware system automatically associates a comment with the relevant region and object of a digital design document. For instance, a reviewing client device adds a comment to a shared digital design document. Moreover, in response to a designer client device (e.g., a client device different than the reviewing client device) opening the shared digital design document, the comment aware system automatically generates an association between the comment, the object, and the layer. Specifically, the comment aware system provides for display an annotation on the object in the layer of the digital design document, where the annotation indicates an association between the comment, the layer, and the object. In one or more embodiments, the comment aware system surfaces an indication of the annotation to a client device that shows the specific layer that the comment is associated with in response to the client device selecting the annotation (e.g., clicking on a pin or a mask on the object).

In one or more embodiments, the comment aware system further updates an association between a comment, object, and layer in response to modifications made to an object. Specifically, the comment aware system generates an initial association between a comment, object, and layer and then receives a modification to the object (e.g., changing the size of the object, the appearance of the object, the position of the object, the orientation of the object, moving the object to another layer, etc.). In response to the modification to the object, the comment aware system generates an updated association between the comment, the object, and the layer. Furthermore, the comment aware system provides for display the annotation based on the modification made to the object (e.g., moves the annotation to be in a location that matches the changes made to the object, in other words, the comment aware system updates the position of the annotation in response to any modifications made to a relevant object).

As also mentioned, the comment aware system uses a text and image transformer model and an object detection model to generate the association between the comment, the layer, and the object. Specifically, the comment aware system processes a digital design document and a comment (e.g., a text comment) via the text and image transformer to generate an output segmentation mask (e.g., a rough segmentation mask). Moreover, the comment aware system processes the output segmentation mask and the digital design document via an object detection model to generate a refined segmentation mask (e.g., a more precise segmentation mask relative to the output segmentation mask). Furthermore, the comment aware system calculates a bounding box from the refined segmentation mask and sends the calculated information to the digital design application to provide for display the annotation (e.g., a graphical user interface element such as a pin).

As mentioned above, conventional systems suffer from a few issues related to computational inaccuracies, inefficiencies, and operational inflexibility. For example, conventional systems suffer from issues of computational inaccuracies due to digital design editing pipelines containing comments that are too generic and lack context. For instance, a reviewing client device often does not provide sufficient context or specificity for a comment, and thus, other client devices accessing the digital design document do not understand the relevance or the context of the comment.

In one or more embodiments, reviewing client devices fail to provide sufficient context or specificity for a comment because often the reviewing client device is working with a merged digital design document (e.g., rather than a multi-layered document). For instance, in a single merged document, the reviewing client device does not see all the objects in the document, and thus, the comment left by the reviewing client device may be irrelevant or inaccurate. Thus, reviewing client devices often leave irrelevant and inaccurate comments.

In addition, conventional systems suffer from issues of computational inefficiency due to collaborating client devices having a repetitive back-and-forth and requiring additional inputs from either one of the reviewing client device or the designer client device. Specifically, conventional systems typically suffer from repeated computational efforts and wasted time in their digital design document editing pipelines. For instance, in conventional systems, designer client devices receive generic or poorly contextualized comments which results in designer client devices making incorrect or inaccurate modifications to a digital design document.

Relatedly, conventional systems suffer from issues of operational inflexibility. Specifically, as mentioned above, conventional systems suffer from inaccurate comments, and inefficiencies in the digital design editing pipeline, which exacerbates the rigidity of existing systems. For instance, conventional systems are not able to efficiently and accurately adapt to an increase in a few collaborating client devices providing comments. For example, when conventional systems experience an increase in a few collaborating client devices, conventional systems have an influx in comments that are inaccurate which leads to an increase in repeated computational efforts and wasted time in digital design editing pipelines.

In one or more embodiments, the comment aware system improves computational accuracy relative to conventional systems. In contrast to conventional systems which receives comments that lack context or specificity, the comment aware system receives a comment (e.g., from a reviewing client device) and generates an association (e.g., a mapping) between the comment, the layer, and the object (e.g., by using the text and image transformer discussed above and below).

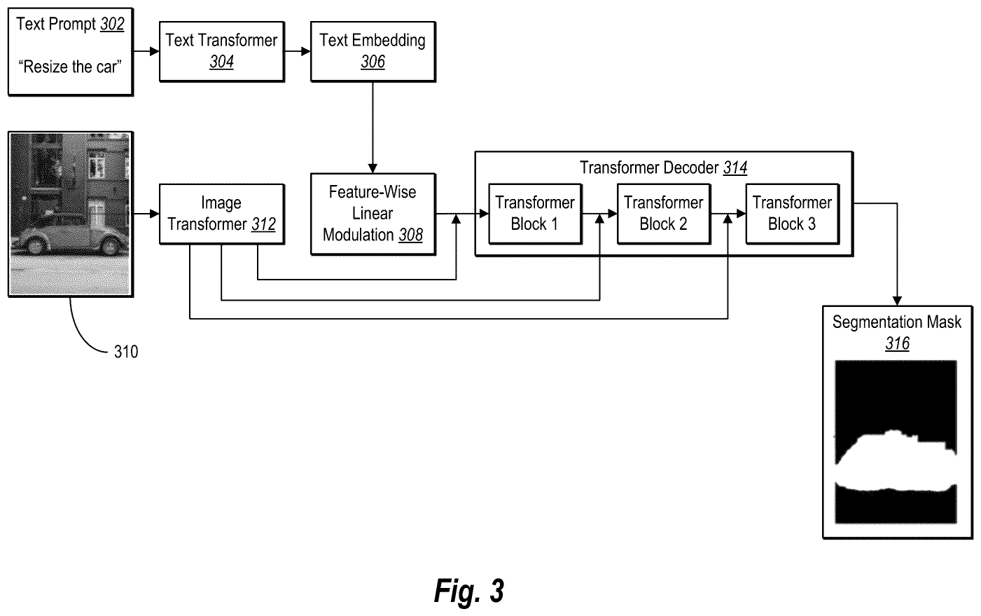

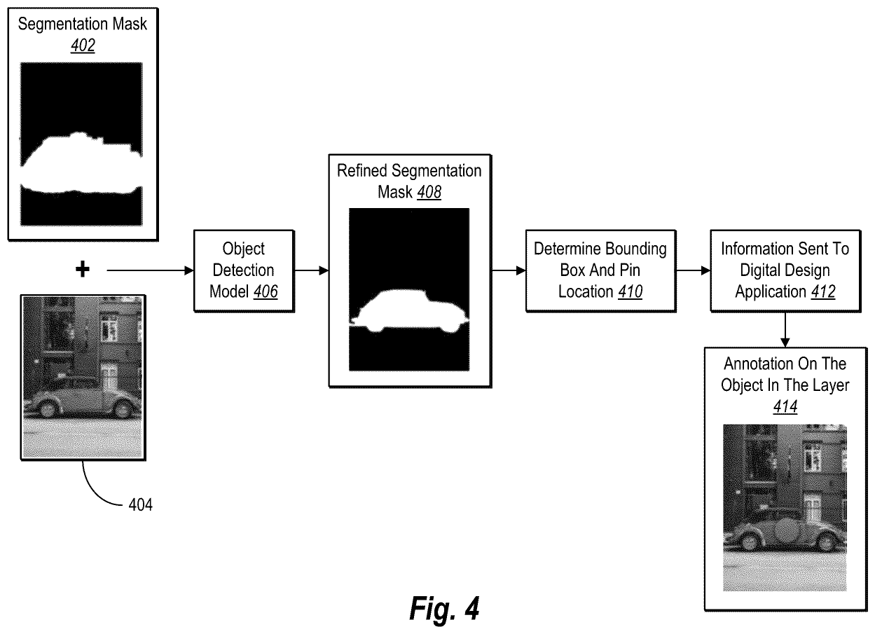

In doing so, the comment aware system automatically adds context and specificity to a comment. For instance, the comment aware system provides for display in a digital design document, an annotation (e.g., a pin) on the object that the comment is related to in the relevant layer. For example, the comment aware system shows the object that the comment is related to and in response to a client device selecting the annotation, the comment aware system notifies the client device (e.g., displays a banner notification in the digital design application) regarding the relevant layer. Accordingly, the comment aware system improves upon accuracy of conventional systems by linking the comment with a relevant object and a relevant layer. The details of this linking process are given below in the description of FIGS. 3 and 4.

In one or more embodiments, the comment aware system improves computational efficiency relative to conventional systems. In contrast to conventional systems which suffer from repetitive use of computational efforts and wasted time (e.g., due to the inaccurate nature of comments in conventional systems), the comment aware system generates the association between the comment, the relevant layer, and the relevant object (e.g., regardless of whether the comment was submitted by a reviewing client device for a single merged document).

In other words, the comment aware system leverages the capabilities of the text and image transformer to automatically detect the relevant object and relevant layer that the comment is referring to, even if the comment was provided in a document with a single layer. Specifically, the comment aware system automatically provides the annotation on the object in the layer of the digital design document, such that a client device is able to clearly comprehend the context of the comment. In doing so, the comment aware system prevents repetitive computational efforts (e.g., back-and-forth between reviewing client device and designer client device) and conserves time.

In addition, the comment aware system improves the graphical user interface for a digital design application. Specifically, the comment aware system streamlines the digital design editing pipeline and reduces the shuffling between multiple user interfaces (e.g., as part of the digital design editing workflow). For instance, the comment aware system provides, for display in the digital design document, the annotation which indicates the association between the comment, the layer, and the object. Thus, the comment aware system provides a clear indication of the association and reduces the inefficiencies of a designer client device attempting to discern the context of the comment by shuffling between multiple different user interfaces.

Relatedly, the comment aware system improves upon operational flexibility relative to conventional systems. For example, the comment aware system adapts to digital design editing pipelines that involves a large number of client devices by improving the efficiency and accuracy of the reviewing process. Specifically, the comment aware system automatically generates the association between the comment, the layer, and the object, and in doing so makes the comment more accurate and improves the overall efficiency of the digital design editing pipeline.

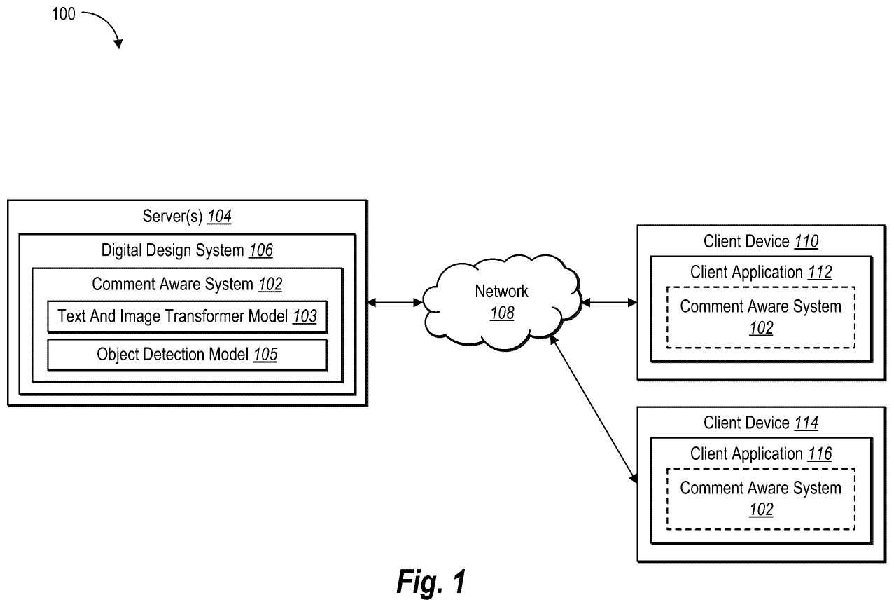

Additional details regarding the comment aware system will now be provided with reference to the figures. For example, FIG. 1 illustrates a schematic diagram of an exemplary system environment 100 in which a comment aware system 102 operates. As illustrated in FIG. 1, the system environment 100 includes server(s) 104, a digital design system 106, a network 108, a client device 110, and a client device 114. Additionally, FIG. 1 illustrates that the digital design system 106 includes the comment aware system 102 and the comment aware system 102 further includes a text and image transformer model 103 and an object detection model 105. Moreover, the client device 110 includes a client application 112 and the client device 114 includes a client application 116.

Although the system environment 100 of FIG. 1 is depicted as having a particular number of components, the system environment 100 is capable of having a different number of additional or alternative components (e.g., a different number of servers, client devices, or other components in communication with the comment aware system 102 via the network 108). Similarly, although FIG. 1 illustrates a particular arrangement of the server(s) 104, the network 108, and the client device 110, various additional arrangements are possible.

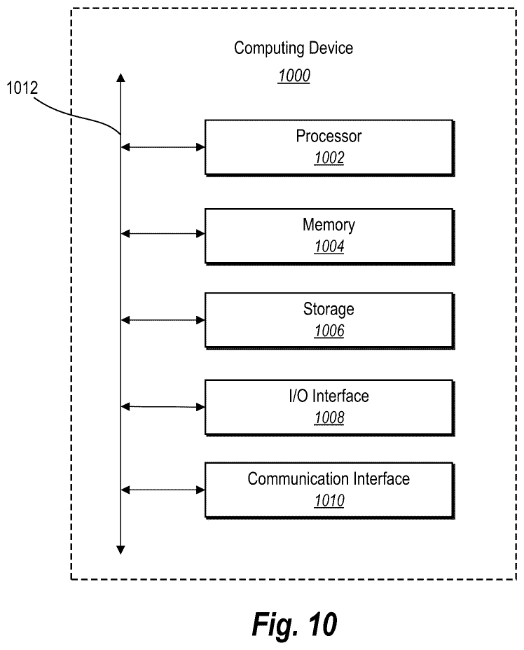

The server(s) 104, the network 108, the client device 110 and the client device 114 are communicatively coupled with each other either directly or indirectly (e.g., through the network 108 discussed in greater detail below in relation to FIG. 10). Moreover, the server(s) 104, the client device 110, and the client device 114 include one or more of a variety of computing devices (including one or more computing devices as discussed in greater detail in relation to FIG. 10).

As mentioned above, the system environment 100 includes the server(s) 104. In one or more embodiments, the server(s) 104 process input for generating an association between a comment, an object, and a layer (e.g., for a digital design document). In one or more embodiments, the server(s) 104 comprise a data server. In some implementations, the server(s) 104 comprise a communication server or a web-hosting server.

In one or more embodiments, the client device 110 and the client device 114 includes computing devices associated with the one or more user accounts that submit comments (e.g., comments) for a digital design document for the comment aware system 102 to generate an association between the comment, the object, and the layer, and to further generate an annotation on the object. For instance, the comment aware system 102 trains one or more models (e.g., the text and image transformer model 103 and the object detection model 105) from training datasets curated by the comment aware system 102.

In one or more embodiments, the client device 110 and the client device 114 includes smartphones, tablets, desktop computers, laptop computers, head-mounted-display devices, or other electronic devices. The client device 110 and the client device 114 includes one or more software applications (e.g., the client application 112 and the client application 116 includes a digital image editing application) for generating a digital design document in accordance with the digital design system 106. In one or more embodiments, the client application 112 and the client application 116 includes a software application hosted on the server(s) 104 accessible by the client device 110 and the client device 114 through another application, such as a web browser.

To provide an example implementation, in one or more embodiments, the comment aware system 102 on the server(s) 104 supports the comment aware system 102 on the client device 110 and the client device 114. For instance, in some cases, the digital design system 106 on the server(s) 104 gathers data and trains the comment aware system 102. In response, the comment aware system 102, via the server(s) 104, provides the information to the client device 110 and/or the client device 114. In other words, the client device 110 and/or the client device 114 obtains (e.g., downloads) the comment aware system 102 from the server(s) 104. Once downloaded, the comment aware system 102 on the client device 110 and/or the client device 114 provides tools for generating an association between a comment, an object, and a layer and further generating a annotation on the object.

In alternative implementations, the comment aware system 102 includes a web hosting application that allows the client device 110 and/or the client device 114 to interact with content and services hosted on the server(s) 104. To illustrate, in one or more implementations, the client device 110 and/or the client device 114 access a software application supported by the server(s) 104. In response, the comment aware system 102 on the server(s) 104 provides the annotation that indicates the association between a comment, a layer, and an object.

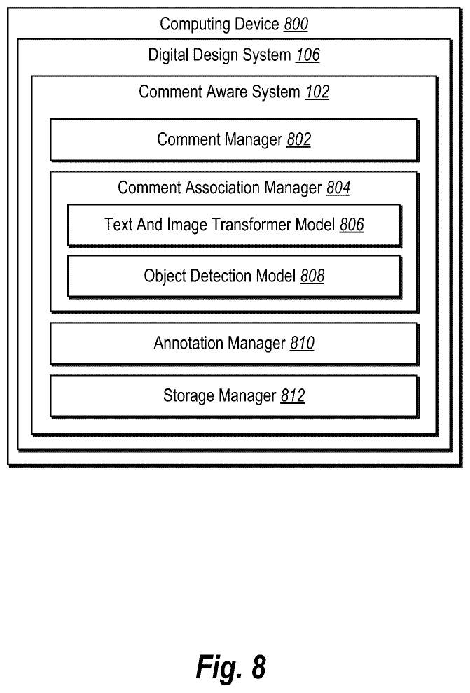

Indeed, in one or more embodiments, the comment aware system 102 is implemented in whole, or in part, by the individual elements of the system environment 100. For instance, although FIG. 1 illustrates the comment aware system 102 implemented or hosted on the server(s) 104, different components of the comment aware system 102 are able to be implemented by a variety of devices within the system environment 100. For example, one or more (or all) components of the comment aware system 102 are implemented by a different computing device or a separate server from the server(s) 104. Indeed, as shown in FIG. 1, the client device 110 and the client device 114 includes the comment aware system 102. Example components of the comment aware system 102 will be described below with regard to FIG. 8.

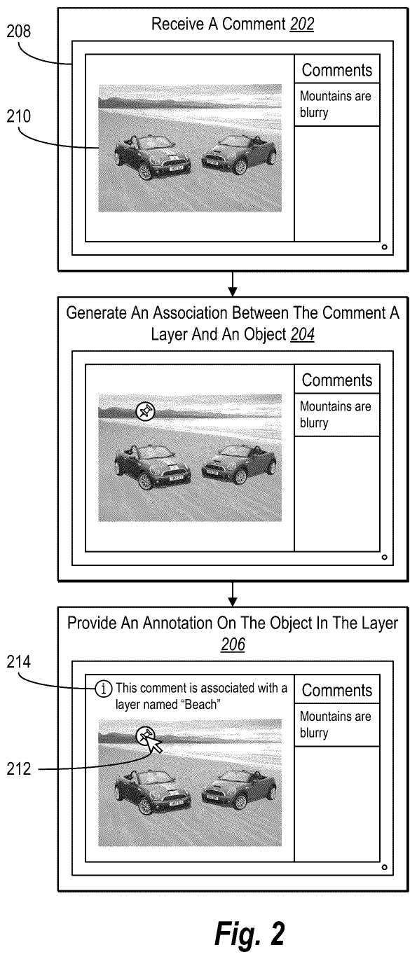

As mentioned above, the comment aware system 102 generates and provides an annotation on the object that indicates an association between a comment, a layer and an object. For example, FIG. 2 illustrates the comment aware system 102 receiving a digital design document 210 via a digital design application 208.

In one or more embodiments, the digital design application 208 includes a software application for client devices to create, manipulate, manage, and review a digital design document. Specifically, the digital design application 208 includes multiple user interface tools to add graphic elements (e.g., text or images), to edit graphic elements, and to leave comments or comments related to elements within the digital design document 210. For instance, the digital design application 208 includes a variety of editing applications for digital invitations, images, and files.

As shown in FIG. 2, the comment aware system 102 receives the digital design document 210. For example, the digital design document 210 includes a file with various design properties. In particular, the digital design document 210 includes digital design elements that fit within a dimension of the digital design document 210. For instance, the digital design document 210 includes digital invitations, digital cards, digital fliers, digital posters, digital images, and various other digital files that include design elements such as text, images, and other artistic elements.

In one or more embodiments, a reviewing client device (e.g., a first client device) adds a comment 202 to the digital design document 210 and submits the comment 202. Further, as shown in FIG. 2, a designer client device opens the digital design document 210, and the comment aware system 102 detects the comment 202 (e.g., “mountains are blurry”). In one or more embodiments, a client device operates within a digital design document workflow. Specifically, the client device includes a designer client device and/or a reviewer client device. For instance, a designer client device creates elements within a digital design document. Moreover, a designer client device submits a created digital design document for review by a reviewer client device. In doing so, the reviewer client device adds comment/feedback to the created digital design document and submits the review (e.g., comments) to the designer client device. Additionally, the designer client device opens the digital design document and reviews the comments left by the reviewer client device. Accordingly, the client device includes any computing device involved in the digital design document editing workflow.

As mentioned, the comment aware system 102 detects the comment 202 in the digital design document 210. In one or more embodiments, the comment 202 includes a note or a textual description added to the digital design document 210 to provide instructions to a client device and/or to provide feedback related to the digital design document 210. Specifically, the comment 202 in the digital design document 210 relates to (e.g., mentions) one or more elements of the digital design document. For instance, in a digital design document workflow, a client device works on creating a digital design document, and another client device works on reviewing the created digital design document. Moreover, the client device reviewing the digital design document adds or leaves a comment for the creator to make one or more modifications to specific elements in the digital design document 210 (e.g., or the creator of the digital design document leaves one or more comments for a reviewing client device).

As further shown in FIG. 2, the comment aware system 102 generates an association 204 between the comment 202, a layer (with an object), and the object in the digital design document 210. In one or more embodiments, a layer includes an individual level within the digital design document 210 that contains objects, images, text and other design elements. Specifically, each layer of the digital design document 210 acts as a stand-alone portion of the digital design document 210 that has a position in a layer hierarchy (e.g., an ordering of layers in the digital design document 210). For instance, the comment aware system 102 positions a layer as being the most forward, the most backward, or somewhere between the most forward and the most backward. In other words, elements on a more forward layer has a depth perception of being closer while elements on a more backward layer has a depth perception of being farther away. To illustrate, a background of a digital design document is typically assigned to the deepest layer (e.g., in contrast, a foreground object of a digital design document is typically assigned the shallowest layer). Moreover, a client device edits a single layer at a time without effecting other elements (e.g., text or image objects) on other layers.

In one or more embodiments, an object includes a collection of pixels in the digital design document 210 that depicts a person, place, text, or thing. To illustrate, in one or more embodiments, an object includes a person, an item (e.g., a car), a natural object (e.g., a tree or rock formation) or a structure depicted in a digital image. For instance, an object includes text that depicts a word or a series of words. In some instances, an object refers to a plurality of elements that, collectively, is distinguishable from other elements depicted in a digital image (e.g., a car or an animal). For example, in some instances, an object includes a collection of buildings that make up a skyline. In some instances, an object more broadly includes a (portion of a) foreground or other element(s) depicted in a digital image as distinguished from a background.

As mentioned above, the comment aware system 102 generates the association 204 between the comment 202, a layer, and an object. Specifically, the association 204 refers to a linkage or mapping between the comment 202, the layer, and the object. For instance, the comment aware system 102 generates a mapping that indicates that a specific comment is associated with a specific layer of the digital design document and is more specifically associated with an object on the specific layer. For example, the comment aware system 102 creates a database with mappings between various comments, layers, and objects. Specifically, the database with the mappings includes a unique identifier for a comment mapped to a unique identifier of a layer and a unique identifier for an object.

As shown, the comment aware system 102 provides for display, an annotation 206 (e.g., a graphical user interface element that indicates a specific comment) on the object. As shown, the comment aware system 102 provides for display the annotation 206 as a pin icon (e.g., the comment aware system 102 automatically adds the annotation in response to the association being generated). In particular, the comment aware system 102 causes the annotation 206 (as the pin icon) to be on the mountain object. For instance, the comment aware system 102 causes the annotation 206 to be on the mountains because the comments are related to the blurriness of the mountains.

Moreover, FIG. 2 shows a selection 212 of the annotation 206. In one or more embodiments, the selection 212 of the annotation 206 includes receiving input from a client device clicking on, selecting, swiping, tapping, or making some gesture on the client device to indicate the selection 212 of the annotation 206. In response to the selection 212 of the annotation 206, the comment aware system 102 generates and provides for display the comment (mountains are blurry) to the client device.

In one or more embodiments, the comment aware system 102 shows the annotation 206 on the object without any selection of the comment 202 or other annotation. In other words, the comment aware system 102 automatically shows the annotation 206 in response to a client device accessing the digital design document 210.

In one or more embodiments, selecting the annotation 206 on the object causes the comment aware system 102 to provide for display an indication 214 of the association 204. Specifically, the indication 214 includes a banner (e.g., an area that spans across a top section of the digital design application 208), a pop-up window (an overlay in the digital design document 210), a tooltip (e.g., a small pop-up box that appears when the client device hovers over a pin element or a mask of the comment 202 associated with the layer and the object), and/or an icon (e.g., a small graphical representation of the association 204 of the comment 202 with the layer and the object). Specifically, the indication 214 includes a description of the comment 202 (e.g., mountains are blurry) being associated with a specific layer and object (e.g., the comment 202 is associated with a layer named “beach” and an object “mountains”). To illustrate, the indication 214 of the association 204 reads “this comment is associated with a layer named beach.”

As mentioned above, the comment aware system 102 utilizes a text and image transformer model to generate an output segmentation mask to identify an object or region to associate with a comment. For example, FIG. 3 illustrates the comment aware system 102 utilizing a text and image transformer model to detect an object that a comment is referring to in a digital design document in accordance with one or more embodiments. Specifically, FIG. 3 illustrates the comment aware system 102 receiving a text prompt 302 that reads “resize the car.” Moreover, FIG. 3 illustrates the comment aware system 102 receiving an digital design document 310 (e.g., a digital image) in conjunction with the text prompt 302.

As shown, the comment aware system 102 processes the digital design document 310 and the text prompt 302 using a text and image transformer model. In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in one or more embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In one or more embodiments, a neural network includes a combination of neural networks or neural network components. Accordingly, the text and image transformer model is a type of neural network that includes a text transformer 304 and an image transformer 312.

In one or more embodiments, a text and image transformer includes a neural network transformer model that connects natural language and visual concepts. In other words, the text and image transformer model includes a multi-modal model trained on both text and image data. For instance, the text and image transformer model includes an image encoder, a text encoder, and a similarity calculation to determine similarity between image and text feature embeddings.

In one or more embodiments, the text and image transformer model processes inputs from both the text and image modalities and further includes a decoder branch that includes n number of transformer layers (in the implementation illustrated in FIG. 3 n is three). Moreover, the comment aware system 102 utilizes the text and image transformer model that includes skip connections (e.g., a neural network architectural component that bypasses one or more layers in a neural network by feeding the input of a certain layer directly to a later layer in the network architecture) between intermediate layers (e.g., layers 3, 7, and 9) of the transformer encoder (e.g., the image transformer) and the decoder branch.

As shown in FIG. 3, the comment aware system 102 processes the text prompt 302 (“resize the car” with a text transformer 304) utilizing a text transformer 304. In one or more embodiments, the text transformer 304 includes a text encoder to convert raw text into numerical representations (e.g., embeddings or vectors). Thus, the comment aware system 102 uses the text transformer 304 to convert natural language of the text prompt 302 into a machine format.

Additionally, the comment aware system 102 includes a natural language parser. In one or more embodiments, the comment aware system 102 utilizes a natural language parser to process the text prompt 302. Specifically, the comment aware system 102 utilizes the natural language parser to analyze natural language in the text prompt 302 and to extract meaningful information and understand the structure of the natural language of the text prompt 302. For instance, the comment aware system 102 uses the natural language parser to identify a subject in the text prompt 302 (e.g., the identified subject for the text prompt 302 is “car”).

To illustrate, the comment aware system 102 utilizes a natural language parser that is pre-trained to perform parsing, named entity recognition, part-of-speech tagging and additional natural language analysis tasks. For instance, the comment aware system 102 utilizes the natural language parser to identify the subject and various adjectives that describe the subject (e.g., the subject of the text prompt 302). For example, the comment aware system 102 utilizes the natural language parser to identify a subject token and further uses child dependencies of the subject token to identify all the adjective in the text prompt 302 used to describe the subject. Specifically, if the comment (e.g., the text prompt) is “move the red car towards the right,” the comment aware system 102 utilizes the natural language parser to identify a subject token of “car” and an adjective of “red.”

As shown in FIG. 3, the comment aware system 102 processes the text prompt 302 utilizing the text transformer 304 and further generates a text embedding 306. In one or more embodiments, a text embedding from a comment (e.g., the text prompt 302) includes a high-dimensional representation of the comment in a numerical format. Specifically, the text embedding from the comment includes an embedding that represents the semantic meaning of the comment.

Moreover, FIG. 3 shows the comment aware system 102 utilizing an image transformer 312 (e.g., encoder) to process the digital design document 310. In one or more embodiments, an image transformer includes a model or algorithm to process, modify, or transform image. For example, the comment aware system 102 utilizes the image transformer 312 to perform image encoding by generating image patches and converting the image tokens into a sequence of tokens. Specifically, the comment aware system 102 utilizes the image transformer 312 to generate positional embeddings that capture spatial information of the digital design document 310 and sematic embeddings that capture the content of the digital design document 310.

In one or more embodiments, the comment aware system 102 utilizes the image transformer 312 to generate an embedding from the digital design document 310. In one or more embodiments, an embedding from the digital design document 310 includes a high-dimensional representation of the digital design document 310 in a numerical format. Specifically, the embedding from the digital design document 310 includes images (e.g., image patches) as vectors generated using the image transformer 312. As illustrated in FIG. 3, the image transformer 312 includes multiple intermediate levels for generating embeddings of the digital design document 310 at different levels of resolution and/or different portions of the digital design document 310.

As shown in FIG. 3, the comment aware system 102 utilizes the image transformer 312 to directly provide input from layers 3, 7, and 9 (e.g., via skip connections) to a transformer decoder 314. Furthermore, FIG. 3 shows the comment aware system 102 providing the text embedding 306 (e.g., from the text transformer 304) to the transformer decoder 314. Specifically, FIG. 3 shows the comment aware system 102 utilizing a feature-wise linear modulation 308 on the text embedding 306. For instance, the comment aware system 102 provides the text embedding 306 to the transformer decoder 314 as a conditional input after processing the text embedding 306 utilizing the feature-wise linear modulation 308. For example, the comment aware system 102 utilizes the feature-wise linear modulation 308 to conditionalize input features (e.g., the text embedding 306) by performing affine transformations on the text embedding 306.

To illustrate, the comment aware system 102 utilizes the feature-wise linear modulation 308 to transform the text embedding 306 and translate (e.g., shift) the text embedding 306 to be compatible with the transformer decoder 314. For instance, the comment aware system 102 utilizes the feature-wise linear modulation 308 to multiply the text embeddings by a matrix to scale, rotate, shear, or reflect the embeddings in a common latent space (e.g., an embedding space). In other words, the feature-wise linear modulation 308 normalizes the text embedding 306 to be compatible with the embeddings of the digital design document 310.

As shown in FIG. 3, the transformer decoder 314 includes multiple transformer blocks. Specifically, the comment aware system 102 utilizes the transformer decoder 314 to generate an output that predicts region(s) of the digital design document 310 that are referred to by the text prompt 302 by using the text embedding 306 and the embedding of the digital design document 310. For instance, the comment aware system 102 utilizes the transformer decoder 314 to generate a prediction/output that targets the general essence of the text embedding 306 and the embedding of the digital design document 310. As shown, the comment aware system 102 feeds as input into the first transformer block an embedding from the 9^{th} layer of the image transformer 312 (e.g., via a skip connection). Moreover, the comment aware system 102 utilizes the first transformer block of the transformer decoder 314 to generate a first output which is combined/concatenated with an embedding from the 7^{th} layer of the image transformer 312. Additionally, the comment aware system 102 utilize the second transformer block of the transformer decoder 314 to generate a second output which is combined/concatenated with an embedding from the 3^{rd} layer of the image transformer 312.

As shown, the comment aware system 102 utilizes the transformer decoder 314 to generate a segmentation mask 316 as the output/prediction from the text embedding 306 (of the text prompt 302) and the embedding of the digital design document 310. In other words, the comment aware system 102 leverages a multi-modal transformer model to identify a portion of a digital design document referred to by a comment.

In one or more embodiments, the segmentation mask 316 includes a map of the digital design document 310 that has an indication for each unit of each element (e.g., whether the unit corresponds to part of an object (or other semantic area) or not). In some implementations, the indication includes a binary indication (e.g., a “1” for units belonging to a foreground object (such as a car) and a “0” for pixels not belonging to the foreground object). In alternative implementations, the indication includes a probability (e.g., a number between 1 and 0) that indicates the likelihood that a unit belongs to an object. In such implementations, the closer the value is to 1, the more likely the unit belongs to an object and vice versa. Thus, the segmentation mask 316 shown in FIG. 3 depicts pixels in the digital design document 310 corresponding to the car.

In one or more embodiments, the comment aware system 102 iteratively compares an identified subject of the text prompt 302 (e.g., obtained from the analysis of the digital design document 310 using the natural language parser) to each layer of the digital design document 310. Specifically, the comment aware system 102 checks for the presence of the identified object (e.g., via the subject) in each layer of the digital design document 310 to determine a relevant layer to which the text prompt 302 (e.g., comment) is referring. To illustrate, if the digital design document 310 contains three layers (e.g., background layer, layer with the car, and the foreground layer (layer with the street)), the comment aware system 102 checks the background layer to determine if the car is present and checks each subsequent layer.

In one or more embodiments, the comment aware system 102 freezes weights of the text and image transformer model during training/optimization. Specifically, the comment aware system 102 modifies weights of the decoder branch during training and keeps the weights of the encoder frozen during training. For example, the comment aware system 102 utilizes a dataset to train the text and image transformer model that includes a plurality of phrases (e.g., 340,000 phrases) with corresponding image masks. For instance, the comment aware system 102 utilizes a dataset that covers a variety of objects (car, man, ball) and the associated physical attributes of the objects (red, blue, short, etc.). Moreover, the dataset includes relationship attributes (e.g., wearing, with, of, etc.).

As mentioned above, the comment aware system 102 generates a refined segmentation mask. In one or more embodiments, the comment aware system 102 utilizes the text and image transformer to generate a segmentation mask (e.g., a rough segmentation mask) that fails to capture finer details. As such, the comment aware system 102 further utilizes an object detection model (e.g., a modified mask region-based convolutional neural network) to generate a refined segmentation mask. For example, as shown in FIG. 4, the comment aware system 102 utilizes an object detection model 406 to refine segmentation masks obtained from the text and image transformer model (e.g., discussed in FIG. 3). Specifically, the comment aware system 102 utilizes the object detection model 406 to detect object(s) and perform segmentation tasks. For instance, the object detection model 406 contains convolutional layers for processing an digital design document 404 to determine objects in the digital design document 404. Moreover, the object detection model 406 contains a branch for predicting segmentation masks for each detected object in the digital design document 404.

Furthermore, the comment aware system 102 modifies the object detection model 406 (e.g., hence the modified mask region-based convolutional neural network) to include a four-channeled input. Specifically, three of the channels are for the digital design document 404 while the fourth channel is for the segmentation mask (e.g., the segmentation mask 316 discussed in FIG. 3).

As shown in FIG. 4, the comment aware system 102 processes a segmentation mask 402 (e.g., the segmentation mask 316 from the text and image transformer model) and the digital design document 404 (e.g., a normalized image). For example, the comment aware system 102 generates a refined segmentation mask 408 from the segmentation mask 402 and the digital design document 404. Specifically, the comment aware system 102 considers the object class as the segmentation mask 402 and anything other than the object class (e.g., everything outside of the segmentation mask 402) is considered as a part of a background class. Thus, the segmentation mask 402 acts as a conditional input for the object detection model 406 to identify objects within the masked region only.

In one or more embodiments, the refined segmentation mask 408 refers to a mask created from the segmentation mask 402 and the digital design document 404. Specifically, the refined segmentation mask 408 includes a border around an identified object/element in the digital design document 404 that is more precise (e.g., within a threshold amount of the actual element/object in the digital design document) than the segmentation mask 402.

As shown in FIG. 4, after obtaining the refined segmentation mask 408, the comment aware system 102 further performs an act 410 of determining bounding box and pin location of a comment. In one or more embodiments, a bounding box includes a border that encloses a given object/element within the digital design document 404. Specifically, a bounding box is rectangular and defined by its width and height. For instance, a bounding box includes coordinates for its top-left corner, bottom right corner, and/or a top-left corner and bottom left corner. Moreover, a bounding box is defined by its coordinates and dimensions and provide both location and size of an object/element.

To illustrate, the comment aware system 102 identifies the minimum and maximum x and y coordinates that enclose the object corresponding to the refined segmentation mask 408. Specifically, the comment aware system 102 defines the bounding box of the object as the x-minimum, y-minimum, x-maximum, and y-maximum. Moreover, the comment aware system 102 determines a pin location of an annotation based on the determined bounding box.

In one or more embodiments, a pin includes an annotation that indicates a comment that is associated with a particular object/element. Specifically, the comment aware system 102 determines a pin location of the pin by determining a center of the bounding box. For instance, the comment aware system 102 utilizes the coordinates of two opposite corners of a bounding box (e.g., the top-left corner (x-minimum, y-minimum) and the bottom-right corner (x-maximum, y-maximum) to determine the center. In particular, the comment aware system 102 calculate an x-center by adding the x-minimum and the x-maximum (e.g., x-minimum+x-maximum) and dividing the sum by two. Moreover, the comment aware system 102 calculates a y-center by adding the y-minimum and the y-maximum (e.g., y-minimum+y-maximum) and dividing the sum by two. In doing so, the comment aware system 102 calculates the center of the bounding box to use as the pin location.

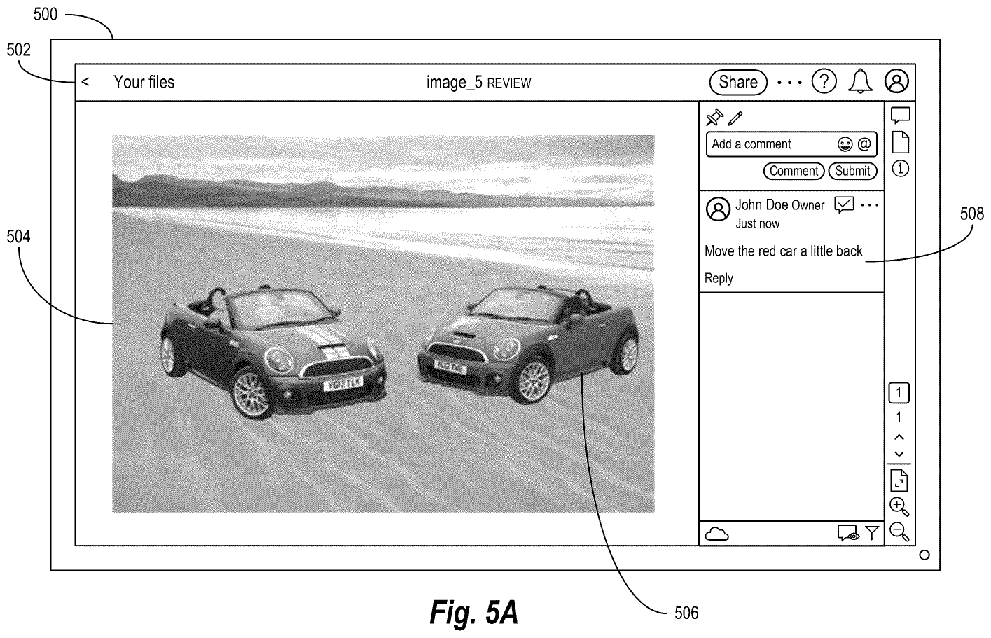

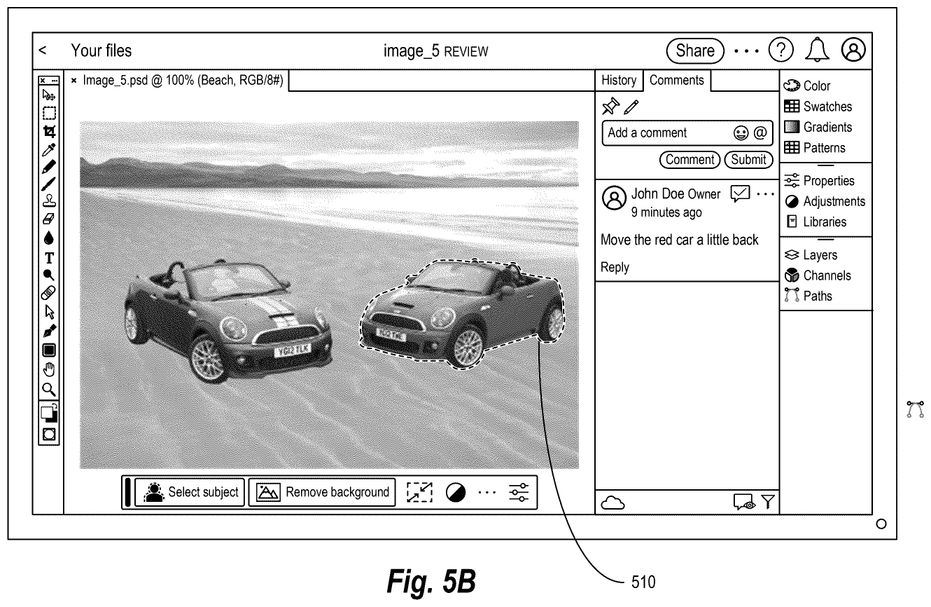

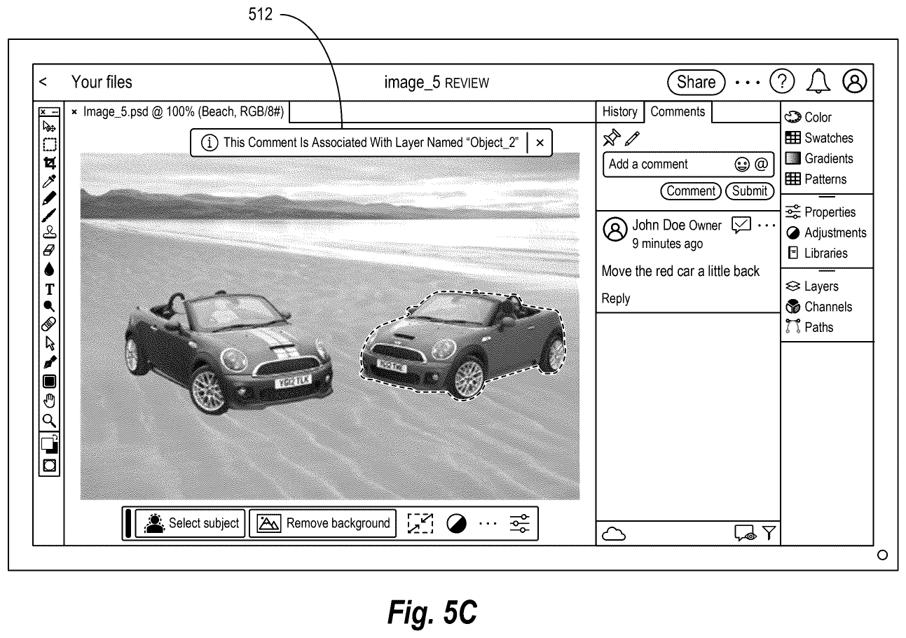

In one or more embodiments, rather than using a pin location, the comment aware system 102 utilizes a mask as the annotation. In one or more embodiments, a mask includes a highlight or a visual indication of an object/element that a comment (e.g., that mentions an object) is associated with. Specifically, a mask includes a dotted border around a specific object/element. Additional examples of the comment aware system 102 utilizing a mask is given below in the description of FIGS. 5A-5C.

FIG. 4 further illustrates the comment aware system 102 performing an act 412 of sending the information of the bounding box and the pin location to a digital design application. Specifically, the comment aware system 102 passes the information of the relevant layer for the comment (e.g., determined by iteratively comparing an identified object with each layer of the digital design document 404), the bounding box information, and the pin location to the digital design application. For instance, the comment aware system 102 stores the position and layer information in an object that the comment is associated with.

As shown in FIG. 4, the comment aware system 102 further generates and provides for display an annotation 414 on the object in the layer of the digital design document 404. Specifically, the comment aware system 102 utilizes the location information to display a pin as the annotation 414 in the digital design document 404. For instance, FIG. 4 shows the comment aware system 102 putting the pin in the center of the car object to indicate that the comment is associated with the car. In one or more embodiments, further selecting the pin (e.g., the annotation 414) causes the comment aware system 102 to provide an indication of the association the layer that the comment is associated with. Additional details of this is given below in the subsequent figures.

In one or more embodiments, the comment aware system 102 trains the object detection model 406 on two classes. Specifically, the comment aware system 102 provides the object detection model 406 (during training time) with a background class and an object class. In doing so, the comment aware system 102 primes the object detection model 406 to consider anything outside of the object class as part of the background class. Thus, the comment aware system 102 optimizes the object detection model 406 to identify more precise boundaries of a segmentation mask (e.g., relative to the segmentation mask discussed in FIG. 3).

FIGS. 5A-5C illustrate example graphical user interfaces of the comment aware system 102 providing an annotation for display in a digital design document. For example, FIG. 5A shows a digital design application 500 causing a graphical user interface 502 to display a digital design document 504 that depicts two cars on a beach with mountains in the background. Specifically, FIG. 5A shows a red car 506 (e.g., the car on the right) and a comment 508 that reads “move the red car a little back.” For instance, FIG. 5A shows the comment 508 originating from “John Doe Owner.”

In one or more embodiments, a first client device created the digital design document 504 and submitted the digital design document 504 for review by a second client device (e.g., John Doe). During review, the second client device creates the comment 508 for the first client device. In response to the first client device opening the digital design document 504 in the digital design application 500, the comment aware system 102 provides for display the comment 508 left by the second client device. In particular, in response to the first client device opening the digital design document 504 with the comment 508, the comment aware system 102 utilizes the text and image transformer model and the object detection model discussed above to generate an association between the comment 508, an object, and a layer.

FIG. 5B illustrates the comment aware system 102 utilizing the text and image transformer model and the object detection model to generate and provide for display a mask 510 as the annotation. Specifically, the mask 510 indicates that the comment 508 is associated with the red car 506 outlined by the mask 510. For instance, the comment aware system 102 processes the comment 508 of “move the red car a little back” (e.g., the comment mentions the object “red car”) to generate a text embedding (e.g., via the text transformer) and further processes the digital design document 504 to generate an embedding of the digital design document 504 to identify the relevant object. To illustrate, the comment aware system 102 generates and provides for display the mask 510 by using the refined segmentation mask (e.g., determined from the object detection model).

FIG. 5C illustrates the comment aware system 102 utilizing the output information from the text and image transformer model to determine the relevant layer of the comment 508. For example, FIG. 5C shows the mask 510, and in response to a selection of the mask, the comment aware system 102 further displays an indicator 512 (e.g., an indication of the association between the comment, the object, and the layer). Specifically, the indicator 512 reads “this comment is associated with layer named object-2.” For instance, the comment aware system 102 iteratively compares a subject from the comment 508 (e.g., red car) with each layer of the digital design document 504 and determines that the red car is on the layer “object_2.”

In one or more embodiments, a reviewing client device leaves a comment for the designer client device to add a beach ball to the digital design document 504. For instance, the digital design document 504 already had a beach ball, however the red (e.g., car on the right) or blue car (e.g., car on the left) is obstructing the beach ball from view in the digital design document 504. As such, when the reviewing client device was reviewing the digital design document 504, the reviewing client device did not know that there was already a beach ball present. Thus, the reviewing client device creates a comment indicating that a beach ball should be added. As such, the comment aware system 102 generates an association between the comment (to add a beach ball) with a layer and the beach ball object (that is obstructed by the red or blue car).

Thus, when a designer client device selects the comment relating to the beach ball needing to be added, the comment aware system 102 provides for display an annotation on the beach ball obstructed by one of the cars. Accordingly, the just-given example illustrates that the comment aware system 102 thoroughly detects all objects in a digital design document (not just visible objects) on each layer of the digital design document 504.

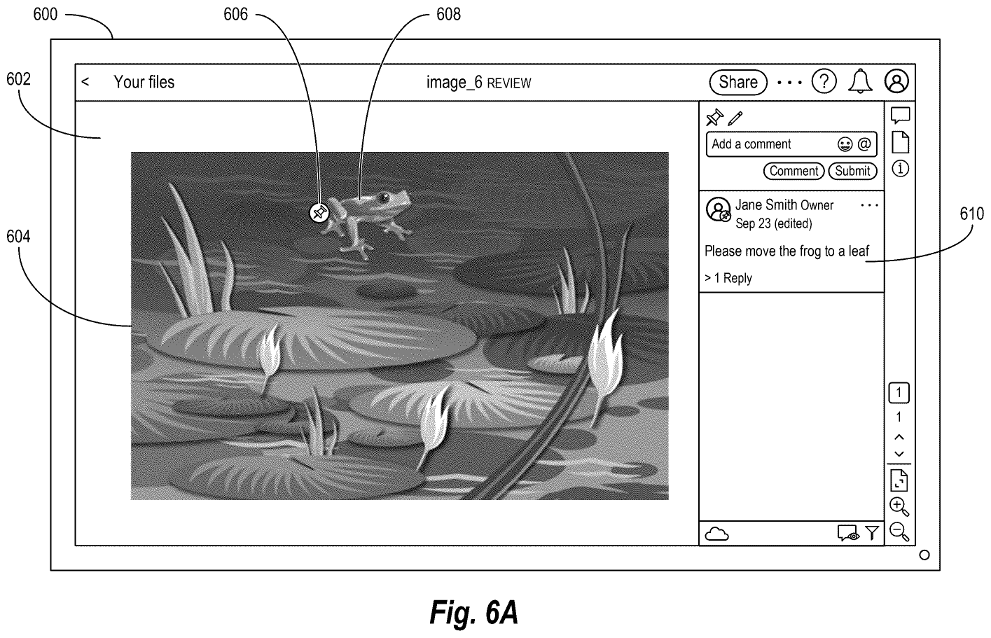

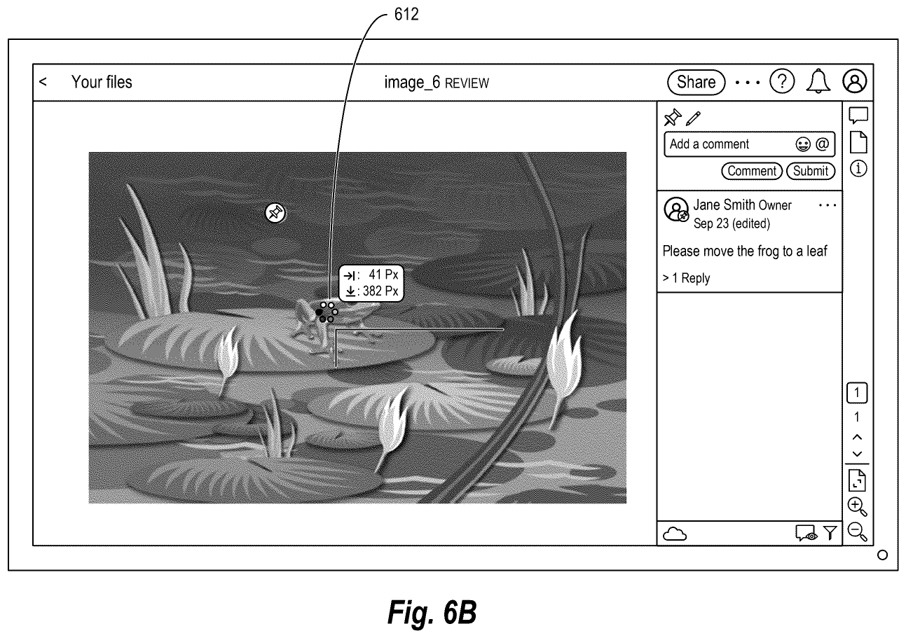

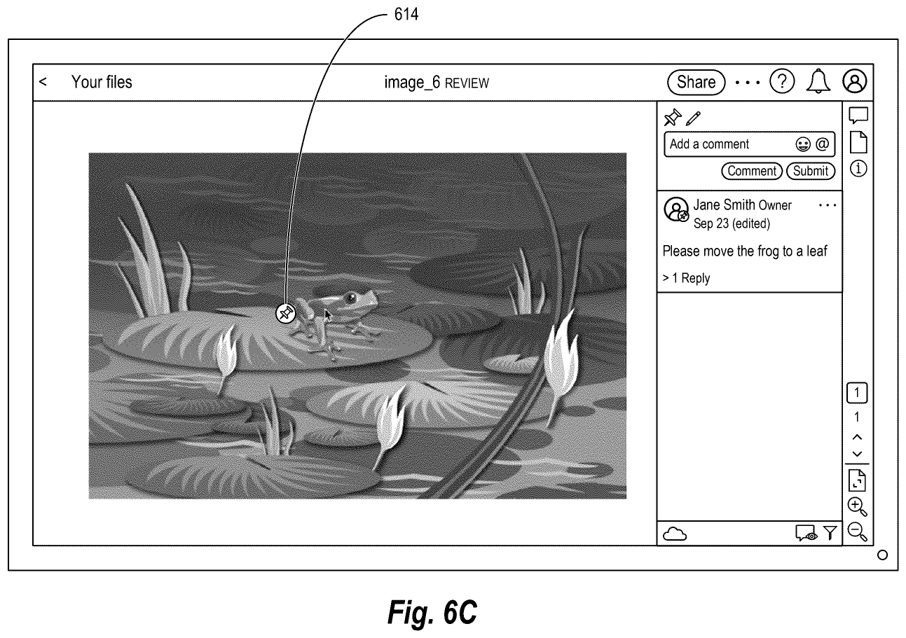

FIGS. 6A-6C illustrates example graphical user interfaces of the comment aware system 102 generating an updated association between a comment, a layer, and an object. FIG. 6A illustrates a digital design application 600 providing for display via a graphical user interface 602 a digital design document 604. For example, FIG. 6A shows a frog object 608 and a pin 606 as the annotation indicating an association between the frog object 608 and a comment 610. Specifically, FIG. 6A shows the comment 610 reading “please move the frog to a leaf.”

FIG. 6B illustrates the comment aware system 102 receiving a modification to the digital design document 604. Specifically, the comment aware system 102 receives a modification 612 that follows the comment 610 of moving the frog object 608 to a leaf in the digital design document 604. In one or more embodiments, the comment aware system 102 receives a modification to the properties or appearance of the digital design document 604. Specifically, the modification includes resizing the dimensions of an element/object, repositioning an element/object, adjusting color in the digital design document 604, adjusting the opacity of an object/element, rotating an object/element, changing the order of layers in the digital design document 604, applying visual effects (shadows, glows, etc.), editing the text in the digital design document 604, clipping an object/element, and skewing/scaling/distorting an object/element.

FIG. 6C shows the comment aware system 102 generating an updated association 614. Specifically, FIG. 6C shows the comment aware system 102 tracking the modifications made to the digital design document 604 and updating a mapping/association between the comment 610, the frog object 608 and a layer of the digital design document 604. For instance, the comment aware system 102 tracks layer modifications. For example, whenever the comment aware system 102 receives a modification to a layer of the digital design document 604, the comment aware system 102 determines whether the modified layer is associated with any comments.

Specifically, the comment aware system 102 compares the information of the modified layer with the information stored in an object linked to a comment. Thus, if a match between the information of the modified layer and the information stored in an object linked to a comment is found, the comment aware system 102 calculates a new position of the annotation (e.g., the pin 606). Accordingly, the type of modification performed on the specific layer of the digital design document 604 influences the new position of the annotation. To illustrate, if a current position of the pin 606 is (X, Y), a modification that includes moving the object by (a, b) results in a new pin position of (X+a, Y+b). Moreover, if an object in a layer is resized by a factor of (x, y) then the new pin position is (X*x, Y*y).

Although FIGS. 6A-6C focus on modifications that include moving the position of an object, in one or more embodiments, the modification includes one or more of changing a position of the object, changing an appearance of the object, and/or changing a layer of the object. For instance, for a change in position, the comment aware system 102 generates an updated association between the comment, the layer, and the object at the position of the modification. Moreover, for a change in appearance to the object (e.g., making the object bigger, inverted, skewed, etc.), the comment aware system 102 calculates an updated central position of the object and provides for display the graphical user interface in the updated central position of the object.

Additionally, for moving the object to a different layer (e.g., different than the initial layer) the comment aware system 102 generates an updated association between the comment, the layer, and the object. In particular, the updated association indicates that the comment is no longer associated with the layer. In response to receiving a selection of the updated annotation that is on a different layer, the comment aware system 102 provides for display an indication that the comment is now associated with a new layer (e.g., an additional layer). In one or more embodiments, in response to generating the updated association 614, the comment aware system 102 automatically provides for display the updated annotation and in response to a selection of the updated annotation, the comment aware system 102 further provides for display an indication of the updated association 614 (e.g., between the comment, the updated layer, and the object).

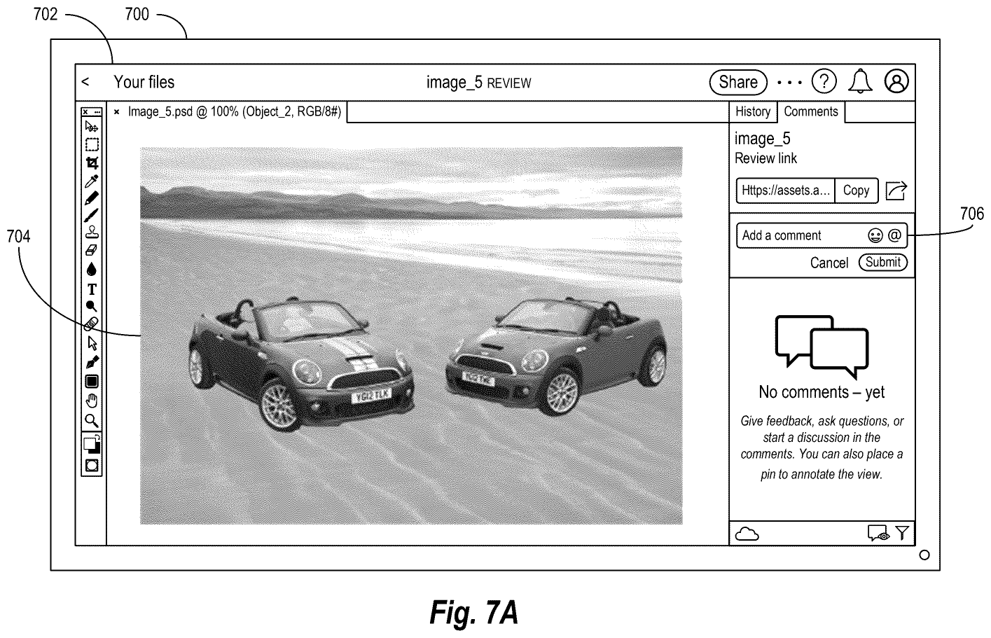

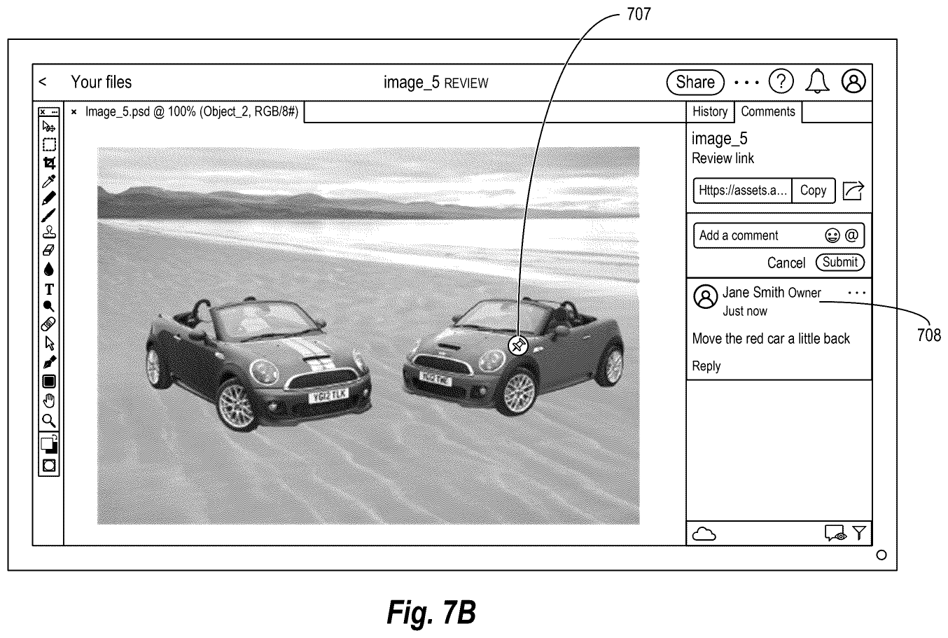

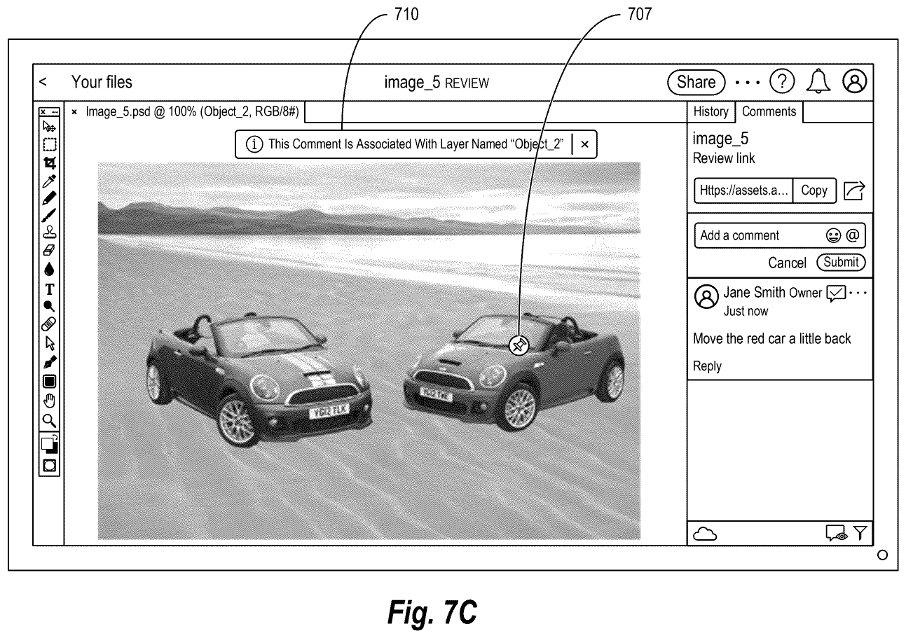

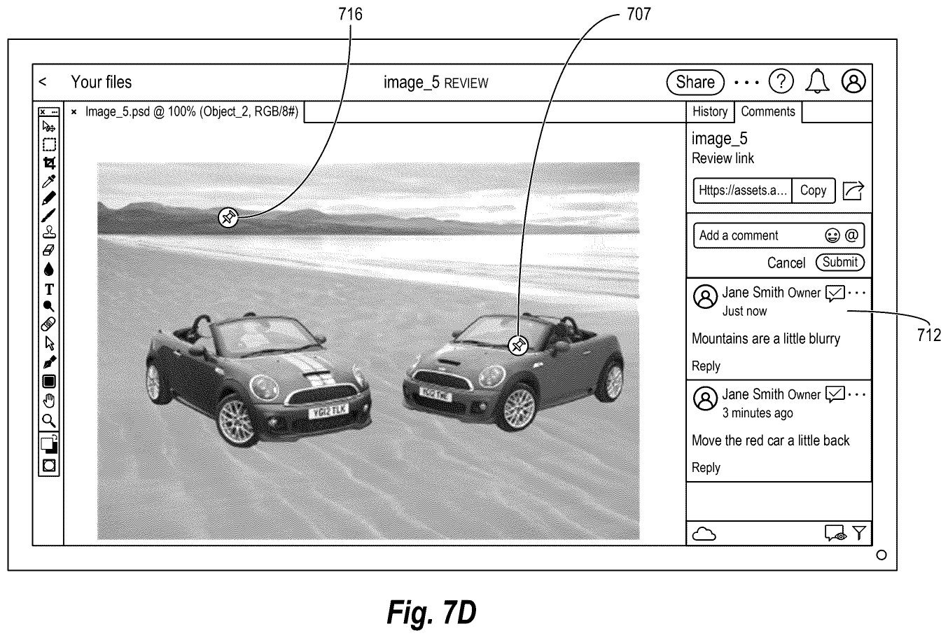

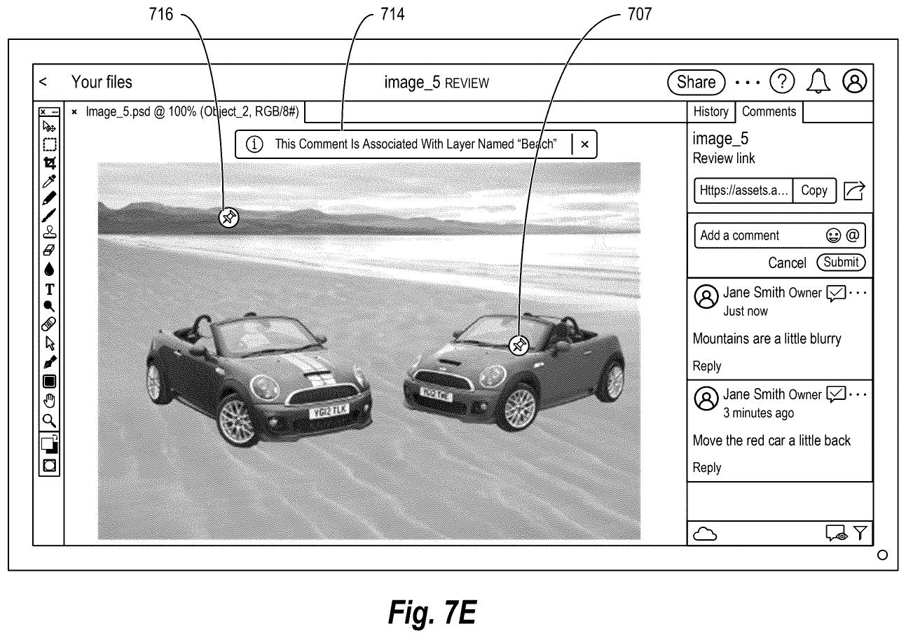

FIGS. 7A-7E illustrate example graphical user interfaces of the comment aware system 102 receiving multiple comments and providing for display the relevant annotations in accordance with one or more embodiments. For example, FIG. 7A shows a digital design application 700 causing a graphical user interface 702 to display a digital design document 704. Moreover, FIG. 7A shows an add comment input element 706 which allows a client device to submit one or more comments.

FIG. 7B shows the comment aware system 102 receiving a comment 708. Specifically, the comment 708 reads “move the red car a little back.” Specifically, FIG. 7B further shows an annotation 707 on the object of the red car. For instance, the comment aware system 102 performs the acts described above to generate an association between the comment, the object (e.g., the red car), and a specific layer in the digital design document 704. In response to generating the association, the comment aware system 102 automatically (e.g., without further user input other than the creation of the comment) provides the annotation 707. Moreover, FIG. 7C shows that upon a selection of the comment 708, the comment aware system 102 causes the graphical user interface 702 to display an indicator 710 that shows that the comment 708 is associated with a specific layer (e.g., a layer named object_2).

Additionally, FIG. 7D shows the comment aware system 102 receiving an additional comment 712. Specifically, the additional comment 712 reads “mountains are a little blurry.” For instance, the additional comment 712 shows an annotation 716 that associates the additional comment 712 with the mountains shown in the digital design document 704. Moreover, FIG. 7E shows that in response to a selection of the annotation 716, that the comment aware system 102 causes the graphical user interface 702 to display an additional indicator 714. In particular, the additional indicator 714 indicates the specific layer that the additional comment 712 is associated with (e.g., the comment is associated with a layer named beach).

Although FIGS. 7A-7E show a graphical user interface based on a selection of a comment, in one or more embodiments, the comment aware system 102 shows all the relevant annotations in the digital design document 704 for all the comments in the digital design document 704. In one or more embodiments, rather than showing an indicator (like the indicators shown in FIGS. 7C and 7E), the comment aware system 102 shows an indicator upon a client device hovering over an annotation.

Moreover, in one or more embodiments, the comment aware system 102 shows the annotation(s) in response to receiving a selection of a comment panel. For instance, the comment aware system 102 initially provides for display the digital design document 704 without a comment panel. Moreover, in one or more embodiments, the comment aware system 102 receives a selection of the comment panel and provides for display the comments associated with the digital design document 704. In response to the selection of the comment panel, the comment aware system 102 performs the actions described in FIGS. 3 and 4 to generate the association between a comment, a layer, and an object.

Turning to FIG. 8, additional detail will now be provided regarding various components and capabilities of the comment aware system 102. In particular, FIG. 8 illustrates an example schematic diagram of a computing device 800 (e.g., the server(s) 104 and/or the client device 110) implementing the comment aware system 102 in accordance with one or more embodiments of the present disclosure for components 800-812. As illustrated in FIG. 8, the comment aware system 102 includes a comment manager 802, a comment association manager 804, a text and image transformer model 806, an object detection model 808, an annotation manager 810, and a storage manager 812.

The comment manager 802 receives a comment from a client device. For example, the comment manager 802 causes a graphical user interface to display an add comment element and receives input from a client device. Furthermore, the comment manager 802 receives input from the client device that includes a comment (e.g., a comment regarding one or more elements in the digital design document). For instance, the comment manager 802 detects the received comment from a client device and passes the received comment to the comment association manager 804.

The comment association manager 804 generates a mapping for a comment. For example, the comment association manager 804 receives the comment from a client device and creates a mapping between the comment, an object, and a layer of the digital design document. Specifically, the comment association manager 804 associates the comment with a specific object in the digital design document and further determines which layer the object is on. Further, in one or more embodiments, the comment association manager 804 leverages the text and image transformer model 806 and the object detection model 808 to determine the relevant object and relevant layer.

The text and image transformer model 806 generates the association between the comment, the layer, and the object. For example, the text and image transformer model 806 generates a text embedding from the comment and further generates an embedding from the digital design document. Further, the text and image transformer model 806 generates a segmentation mask from the text embedding and the embedding from the digital design document.

The object detection model 808 works with the text and image transformer model 806. For example, the object detection model 808 generates a refined segmentation mask from the segmentation mask and the digital design document. For instance, the object detection model 808 detects objects within an digital design document and further generates segmentation masks corresponding to the detected objects. Furthermore, the object detection model 808 passes information to the annotation manager 810.

The annotation manager 810 generates an annotation. For example, the annotation manager 810 generates the annotation based on the association between the comment, the layer, and the object. Furthermore, the annotation manager 810 automatically provides, for display in the digital design document (e.g., in response to generating the association), the annotation on the object in the layer of the digital design document. Moreover, the annotation manager 810 provides for display the annotation. In some embodiments, in response to selecting the annotation, the annotation manager 810 further causes the graphical user interface to display an indication of the association between the comment, the layer, and the object.

The storage manager 812 stores one or more items generated by the comment aware system 102. For example, the storage manager 812 stores digital design documents, objects/elements in digital design documents, layer data in the digital design documents, comments, associations between comments and one or more layers and one or more objects, annotations (e.g., pins and masks), and indicators (e.g., indicating a specific layer that a comment is related to). For instance, the storage manager 812 further stores fine-tuning/training data, loss functions, training datasets (e.g., with training phrases), and image datasets.

Each of the components 802-812 of the comment aware system 102 can include software, hardware, or both. For example, the components 802-812 can include one or more instructions stored on a computer-readable storage medium and executable by processors of one or more computing devices, such as a client device or server device. When executed by the one or more processors, the computer-executable instructions of the comment aware system 102 can cause the computing device(s) to perform the methods described herein. Alternatively, the components 802-812 can include hardware, such as a special-purpose processing device to perform a certain function or group of functions. Alternatively, the components 802-812 of the comment aware system 102 can include a combination of computer-executable instructions and hardware.

Furthermore, the components 802-812 of the comment aware system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 802-812 of the comment aware system 102 may be implemented as a stand-alone application, such as a desktop or mobile application. Furthermore, the components 802-812 of the comment aware system 102 may be implemented as one or more web-based applications hosted on a remote server. Alternatively, or additionally, the components 802-812 of the comment aware system 102 may be implemented in a suite of mobile device applications or “apps.” For example, in one or more embodiments, the comment aware system 102 can comprise or operate in connection with digital software applications such as ADOBE® EXPRESS, ADOBE® PHOTOSHOP®, ADOBE® PHOTOSHOP® ELEMENTS, PHOTOSHOP® LIGHTROOM, LIGHTROOM MOBILE, PHOTOSHOP® MOBILE, PHOTOSHOP® EXPRESS, and PHOTOSHOP® CC.

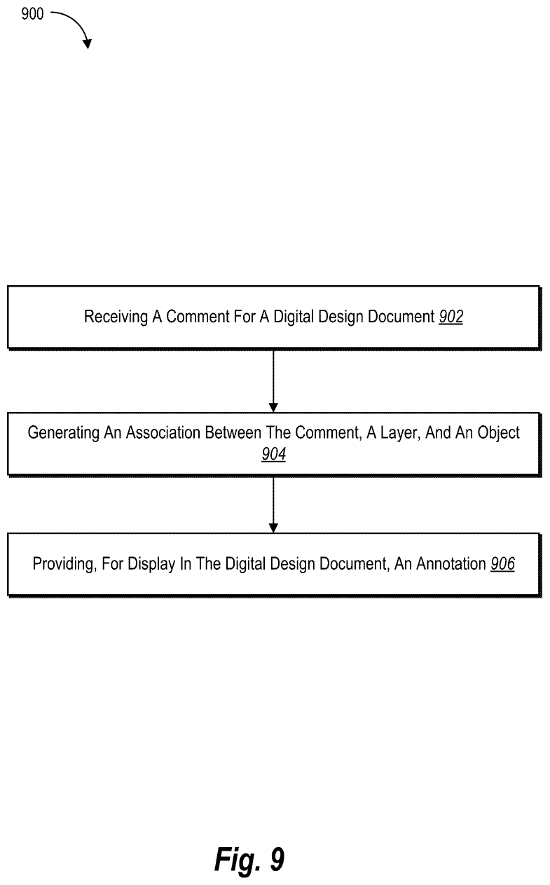

FIGS. 1-8, the corresponding text, and the examples provide a number of different methods, systems, devices, and non-transitory computer-readable media of the components 802-812. In addition to the foregoing, one or more embodiments can also be described in terms of flowcharts comprising acts for accomplishing the particular result, as shown in FIG. 9. FIG. 9 may be performed with more or fewer acts. Further, the acts may be performed in different orders. Additionally, the acts described herein may be repeated or performed in parallel with one another or in parallel with different instances of the same or similar acts.

FIG. 9 illustrates a flowchart of a series of acts 900 for generating a modified digital image in accordance with one or more embodiments. FIG. 9 illustrates acts according to one embodiment, alternative embodiments may omit, add to, reorder, and/or modify any of the acts shown in FIG. 9. In some implementations, the acts of FIG. 9 are performed as part of a method. For example, in one or more embodiments, the acts of FIG. 9 are performed as part of a computer-implemented method. Alternatively, a non-transitory computer-readable medium can store instructions thereon that, when executed by at least one processor, cause a computing device to perform the acts of FIG. 9. In one or more embodiments, a system performs the acts of FIG. 9. For example, in one or more embodiments, a system includes at least one memory device. The system further includes at least one server device configured to cause the system to perform the acts of FIG. 9.

The series of acts 900 includes an act 902 of receiving a comment for a digital design document. Further, the act 904 includes an act of generating an association between the comment, a layer, and an object. Moreover, series of acts 900 includes an act 906 of providing, for display in the digital design document, an annotation. In particular, the act 902 includes receiving a comment for a digital design document comprising one or more layers and one or more objects, the comment mentioning an object of the one or more objects. Moreover, the act 904 includes generating an association between the comment, a layer of the one or more layers with the object, and the object of the one or more objects. Further, the act 906 includes providing, for display in the digital design document, an annotation on the object in the layer of the digital design document, the annotation indicating the association between the comment, the layer, and the object.

For example, in one or more embodiments, the series of acts 900 includes receiving the comment for the digital design document from a first client device. In addition, in one or more embodiments, the series of acts 900 includes receiving an indication of a second client device accessing the digital design document with the comment in a digital design application. Further, in one or more embodiments, the series of acts 900 includes generating the association between the comment, the layer, and the object in response to the second client device accessing the digital design document. Further, in one or more embodiments, the series of acts 900 includes generating, utilizing a text and image transformer model, a text embedding from the comment.

Moreover, in one or more embodiments, the series of acts 900 includes generating, utilizing the text and image transformer model, an embedding from the digital design document. Moreover, in one or more embodiments, the series of acts 900 includes generating a segmentation mask from the text embedding and the embedding from the digital design document. Further, in one or more embodiments, the series of acts 900 includes generating a refined segmentation mask from the segmentation mask and the digital design document.

Moreover, in one or more embodiments, the series of acts 900 includes determining a bounding box of a refined segmentation mask of the object. Additionally, in one or more embodiments, the series of acts 900 includes generating, from the bounding box of the refined segmentation mask, the annotation indicating the association between the comment, the layer, and the object. Moreover, in one or more embodiments, series of acts 900 includes determining a pin location of the association between the comment and the layer and the object by determining a center location of a bounding box of the object. Further, in one or more embodiments, the series of acts 900 includes providing, for display in the digital design document, a pin as the annotation at the pin location.

Furthermore, in one or more embodiments, the series of acts 900 includes generating a mask of the object. Moreover, in one or more embodiments, the series of acts 900 includes providing, for display in the digital design document, the mask as the annotation. In one or more embodiments, the series of acts 900 includes receiving a modification to the object associated with the comment. Moreover, in one or more embodiments, the series of acts 900 includes generating an updated annotation based on the modification to the object.

Further, in one or more embodiments, the series of acts 900 includes receiving a comment for a digital design document comprising one or more layers and one or more objects. Moreover, in one or more embodiments, the series of acts 900 includes generating, utilizing a text and image transformer model, an association between the comment, an object of the one or more objects mentioned in the comment, and a layer of the one or more layers including the object. Further, in one or more embodiments, the series of acts 900 includes providing, for display in the digital design document, an annotation on the object in the layer of the digital design document, the annotation indicating the association between the comment, the layer, and the object. In one or more embodiments, the series of acts 900 includes receiving a modification to the object associated with the comment. Further, in one or more embodiments, the series of acts 900 includes generating an updated association between the comment, the layer, and the object based on the modification to the object.

In one or more embodiments, the series of acts 900 includes receiving an indication of a first client device accessing the digital design document with the comment in a digital design application, wherein the comment was created by a second client device. Further, in one or more embodiments, the series of acts 900 includes generating the association in response to the first client device accessing the digital design document. Moreover, in one or more embodiments, the series of acts 900 includes generating, utilizing the text and image transformer model, the association between the comment, the object of the one or more objects mentioned in the comment, and the layer of the one or more layers including the object by processing, utilizing a natural language parser, the comment to identify a subject in the comment. Further, in one or more embodiments, the series of acts 900 includes generating, utilizing a text and image transformer model, a text embedding from the subject in the comment.

Moreover, in one or more embodiments, the series of acts 900 includes generating, utilizing the text and image transformer model, an embedding from the digital design document. Further, in one or more embodiments, the series of acts 900 includes comparing the subject in the comment to each layer of the digital design document to determine a presence of the object in the one or more layers of the digital design document. Moreover, in one or more embodiments, the series of acts 900 includes generating, utilizing the text and image transformer model, a segmentation mask of the object from the embedding from the digital design document and the text embedding.

Additionally, in one or more embodiments, the series of acts 900 includes generating, utilizing an object detection model, a refined segmentation mask from the segmentation mask and the digital design document. Moreover, in one or more embodiments, the series of acts 900 includes determining a bounding box of the refined segmentation mask of the object. Further, in one or more embodiments, the series of acts 900 includes calculating a central location of the bounding box for the refined segmentation mask. Moreover, in one or more embodiments, the series of acts 900 includes providing, for display in the digital design document, the annotation on the object in the layer of the digital design document at the central location of the bounding box.

Further, in one or more embodiments, the series of acts 900 determining a pin location of the association between the comment and the layer and the object by determining a center location of a bounding box of the object. In one or more embodiments, the series of acts 900 includes determining a mask of the object. Further, in one or more embodiments, the series of acts 900 includes providing, for display in the digital design document, at least one of a pin as the annotation at the pin location or the mask as the annotation.

Moreover, in one or more embodiments, the series of acts 900 includes receiving the modification to the object associated with the comment comprises receiving input to move the object to an updated position. In one or more embodiments, the series of acts 900 includes generating the updated association between the comment and the object at the updated position. Further, in one or more embodiments, the series of acts 900 includes providing, for display in the digital design document, the annotation on the object at the updated position.

Further, in one or more embodiments, the series of acts 900 includes receiving a comment for a digital design document comprising one or more layers and one or more objects, the comment mentioning an object of the one or more objects. Moreover, in one or more embodiments, the series of acts 900 includes generating an association between the comment, a layer of the one or more layers with the object, and the object of the one or more objects. In one or more embodiments, the series of acts 900 includes providing, for display in the digital design document, an annotation on the object in the layer of the digital design document, the annotation indicating the association between the comment, the layer, and the object. Further, in some embodiments, the series of acts 900 includes in response to a selection of the annotation, surfacing an indication of the association between the comment, the layer, and the object.

Moreover, in one or more embodiments, the series of acts 900 includes receiving the comment for the digital design document from a first client device. Further, in one or more embodiments, the series of acts 900 includes in response to a selection of a comment panel by a second client device, generating the association between the comment, the layer of the one or more layers with the object, and the object of the one or more objects. In one or more embodiments, the series of acts 900 includes generating, utilizing a text and image transformer model, a text embedding from the comment. Further, in one or more embodiments, the series of acts 900 includes generating, utilizing the text and image transformer model, an embedding from the digital design document. Moreover, in one or more embodiments, the series of acts 900 includes generating a segmentation mask from the text embedding and the embedding from the digital design document. Further, in one or more embodiments, the series of acts 900 includes generating the association between the comment, the layer, and the object from a refined segmentation mask generated from the segmentation mask and the digital design document.

In one or more embodiments, the series of acts 900 includes receiving a modification to the object associated with the comment comprises receiving input to move the object to an updated position, wherein the updated position comprises an additional layer of the digital design document different than the layer. Further, in one or more embodiments, the series of acts 900 includes generating an updated association between the comment and the object at the updated position. In one or more embodiments, the series of acts 900 includes providing, for display in the digital design document, the annotation on the object in the updated position.

In one or more embodiments, the series of acts 900 includes receiving a modification to the object associated with the comment comprises receiving input to move the object to an updated position, wherein the updated position comprises an additional layer of the digital design document different than the layer and an updated location of the object relative to an initial location of the object. Further, in one or more embodiments, the series of acts 900 includes generating an updated association between the comment and the object at the updated position. In one or more embodiments, the series of acts 900 includes providing, for display in the digital design document, the annotation on the object in the updated position.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., the server(s) 104 and/or the client device 110). In one or more embodiments, the computing device 1000 may be a mobile device (e.g., a mobile telephone, a smartphone, a PDA, a tablet, a laptop, a camera, a tracker, a watch, a wearable device). In one or more embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 include hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 including storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium comprising instructions that, when executed by at least one processor, cause the at least one processor to perform operations comprising:
receiving a comment for a digital design document comprising one or more layers and one or more objects, the comment mentioning an object of the one or more objects;
generating an association between the comment, a layer of the one or more layers with the object, and the object of the one or more objects; and
providing, for display in the digital design document, an annotation on the object in the layer of the digital design document, the annotation indicating the association between the comment, the layer, and the object.

2. The non-transitory computer-readable medium of claim 1, further comprising:
receiving the comment for the digital design document from a first client device;
receiving an indication of a second client device accessing the digital design document with the comment in a digital design application; and
generating the association between the comment, the layer, and the object in response to the second client device accessing the digital design document.

3. The non-transitory computer-readable medium of claim 1, wherein generating the association between the comment, the layer, and the object further comprises:
generating, utilizing a text and image transformer model, a text embedding from the comment; and
generating, utilizing the text and image transformer model, an embedding from the digital design document.

4. The non-transitory computer-readable medium of claim 3, further comprising:
generating a segmentation mask from the text embedding and the embedding from the digital design document; and
generating a refined segmentation mask from the segmentation mask and the digital design document.

5. The non-transitory computer-readable medium of claim 1, further comprising:
determining a bounding box of a refined segmentation mask of the object; and
generating, from the bounding box of the refined segmentation mask, the annotation indicating the association between the comment, the layer, and the object.

6. The non-transitory computer-readable medium of claim 1, further comprising:
determining a pin location of the association between the comment and the layer and the object by determining a center location of a bounding box of the object; and
providing, for display in the digital design document, a pin as the annotation at the pin location.

7. The non-transitory computer-readable medium of claim 1, further comprising:
generating a mask of the object; and
providing, for display in the digital design document, the mask as the annotation.

8. The non-transitory computer-readable medium of claim 1, further comprising:
receiving a modification to the object associated with the comment; and
generating an updated annotation based on the modification to the object.

9. A system comprising:
one or more memory devices; and
one or more processors coupled to the one or more memory devices that cause the system to perform operations comprising:
receiving a comment for a digital design document comprising one or more layers and one or more objects;
generating, utilizing a text and image transformer model, an association between the comment, an object of the one or more objects mentioned in the comment, and a layer of the one or more layers including the object;
providing, for display in the digital design document, an annotation on the object in the layer of the digital design document, the annotation indicating the association between the comment, the layer, and the object;
receiving a modification to the object associated with the comment; and
generating an updated association between the comment, the layer, and the object based on the modification to the object.

10. The system of claim 9, wherein the at least one processor further causes the system to perform the operations comprising:
receiving an indication of a first client device accessing the digital design document with the comment in a digital design application, wherein the comment was created by a second client device; and
generating the association in response to the first client device accessing the digital design document.

11. The system of claim 9, wherein the at least one processor further causes the system to generate, utilizing the text and image transformer model, the association between the comment, the object of the one or more objects mentioned in the comment, and the layer of the one or more layers including the object by:
processing, utilizing a natural language parser, the comment to identify a subject in the comment;
generating, utilizing the text and image transformer model, a text embedding from the subject in the comment; and
generating, utilizing the text and image transformer model, an embedding from the digital design document.

12. The system of claim 11, wherein the at least one processor further causes the system to perform the operations comprising:
compare the subject in the comment to each layer of the digital design document to determine a presence of the object in the one or more layers of the digital design document; and
generate, utilizing the text and image transformer model, a segmentation mask of the object from the embedding from the digital design document and the text embedding.

13. The system of claim 12, wherein the at least one processor further causes the system to perform the operations comprising:
generate, utilizing an object detection model, a refined segmentation mask from the segmentation mask and the digital design document;
determine a bounding box of the refined segmentation mask of the object;
calculate a central location of the bounding box for the refined segmentation mask; and
provide, for display in the digital design document, the annotation on the object in the layer of the digital design document at the central location of the bounding box.

14. The system of claim 9, wherein the at least one processor further causes the system to perform the operations comprising:
determine a pin location of the association between the comment and the layer and the object by determining a center location of a bounding box of the object; or
determine a mask of the object; and
provide, for display in the digital design document, at least one of a pin as the annotation at the pin location or the mask as the annotation.

15. The system of claim 9, wherein
receiving the modification to the object associated with the comment comprises receiving input to move the object to an updated position;
generate the updated association between the comment and the object at the updated position; and
provide, for display in the digital design document, the annotation on the object at the updated position.

16. A computer-implemented method comprising:
receiving a comment for a digital design document comprising one or more layers and one or more objects, the comment mentioning an object of the one or more objects;
generating an association between the comment, a layer of the one or more layers with the object, and the object of the one or more objects;
providing, for display in the digital design document, an annotation on the object in the layer of the digital design document, the annotation indicating the association between the comment, the layer, and the object; and
in response to a selection of the annotation, surfacing an indication of the association between the comment, the layer, and the object.

17. The computer-implemented method of claim 16, further comprising:
receiving the comment for the digital design document from a first client device; and
in response to a selection of a comment panel by a second client device, generating the association between the comment, the layer of the one or more layers with the object, and the object of the one or more objects.

18. The computer-implemented method of claim 16, further comprising:
generating, utilizing a text and image transformer model, a text embedding from the comment;
generating, utilizing the text and image transformer model, an embedding from the digital design document;
generating a segmentation mask from the text embedding and the embedding from the digital design document; and
generating the association between the comment, the layer, and the object from a refined segmentation mask generated from the segmentation mask and the digital design document.

19. The computer-implemented method of claim 16, further comprising:
receiving a modification to the object associated with the comment comprises receiving input to move the object to an updated position, wherein the updated position comprises an additional layer of the digital design document different than the layer;
generating an updated association between the comment and the object at the updated position; and
providing, for display in the digital design document, the annotation on the object in the updated position.

20. The computer-implemented method of claim 16, further comprising:
receiving a modification to the object associated with the comment comprises receiving input to move the object to an updated position, wherein the updated position comprises an additional layer of the digital design document different than the layer and an updated location of the object relative to an initial location of the object;
generating an updated association between the comment and the object at the updated position; and
providing, for display in the digital design document, the annotation on the object in the updated position.
